(19) United States
(12) Patent Application Publication
(10) Pub. No.: US 2026/0320530 A1
(43) Pub. Date: Oct. 15, 2026

(54) SYSTEM AND METHOD FOR BALANCING ECONOMIC AND ENVIRONMENTAL KPIS IN BUSINESS DECISION MAKING

(71) Applicant: HITACHI, Ltd., Tokyo (JP)

(72) Inventors: Manish GUPTA, Sunnyvale, CA (US); Umeshwar DAYAL, Saratoga, CA (US); Hiroaki NASU, Cupertino, CA (US)

(21) Appl. No.: 19/173,600

(22) Filed: Apr. 8, 2025

(51) Int. Cl. G06Q 10/0637; G06Q 10/0639

(52) U.S. Cl. CPC G06Q 10/0637; G06Q 10/06393

(57) ABSTRACT

Systems and methods as described herein can involve collecting data from stakeholders in an industrial value-chain; defining and measuring economic key performance indicators (KPIs) and environmental KPIs based on the collected data; formulating a multi-objective optimization problem balancing the economic KPIs and environmental KPIs to generate one or more solutions; computing a social responsibility score (SRS) for the one or more solutions based on the multi-objective optimization; selecting a solution from the one or more solutions for execution across the industrial value chain based on the computed SRS, and executing the selected solution on affected stakeholders across the industrial value chain.

### BACKGROUND

### Field

The present disclosure is generally directed to supply chain management, and more specifically, to environmental and economic management of supply chains through an intake system.

### Related Art

The transition to a circular economy (CE) is essential for mitigating critical environmental challenges and achieving long-term resource sustainability. A true CE aims to eliminate waste and maximize resource utilization through strategies such as reuse, remanufacturing, and recycling. While the CE offers substantial potential benefits—including reduced environmental impact, enhanced resource security, and new economic opportunities—its realization demands a fundamental shift in business operations and decision-making processes. This shift requires a comprehensive, integrated assessment and optimization of both economic and environmental performance across the entire value chain.

Current industry practices predominantly prioritize traditional economic Key Performance Indicators (KPIs) such as revenue, profit margins, and cost reduction. Environmental considerations are often treated as secondary concerns which are primarily driven by regulatory compliance or as broad corporate sustainability targets (e.g., achieving carbon neutrality). This siloed approach, where economic and environmental performance are evaluated separately, creates a critical impediment to transforming to circularity. This approach in the related art fails to capture the complex interdependencies between economic and environmental factors, and it frequently leads to suboptimal decisions that favor short-term financial gains over long-term sustainability and resource efficiency.

The integration of sustainability into business operations management has become increasingly important. Various approaches in the related art have been developed to incorporate environmental factors into decision-making processes or to provide metrics to inform those decisions. However, many existing methods focus narrowly on specific environmental aspects (e.g., energy consumption, carbon emissions, or waste generation) in isolation.

A comprehensive, multi-dimensional view that considers the broader context of the circular economy and integrates environmental performance with economic considerations is often lacking in the related art. This limits the ability to make informed decisions that balance profitability with environmental responsibility and resource efficiency.

### SUMMARY

Businesses need a systematic approach to quantify the benefits of sustainability and circularity and evaluating them against economic impact. This requires accurately measuring reductions in energy use, emissions, water use, material circulation and waste generation, and then directly comparing these environmental improvements against economic metrics. Such a comparison necessitates a systems-level approach to data collection and analysis, encompassing the entire value chain. Further, a structured framework is needed for:
1. Defining a comprehensive set of relevant economic and environmental KPIs (covered in our earlier disclosure)
2. Measuring these KPIs accurately and consistently across the value chain. (covered in our earlier disclosure)
3. Simultaneously Optimizing these KPIs, enabling informed trade-off decisions that balance economic viability with environmental responsibility and circularity principles.

Lack of such an integrated framework and methodology represents a significant barrier to the widespread adoption of sustainability and circular economy practices. It hinders the ability of businesses to make truly informed, data-driven decisions that promote both profitability and long-term sustainability.

Adoption of sustainability and circularity approaches by businesses is hindered by a fundamental challenge: the lack of a practical, integrated decision-support framework that simultaneously optimizes economic and environmental performance. Current business decision-making prioritizes economic Key Performance Indicators (KPIs), such as revenue growth, profit maximization, and cost reduction. Environmental considerations are often relegated to secondary status, driven primarily by the need for regulatory compliance or by broad corporate sustainability targets (e.g., carbon neutrality by a specific year). This creates a significant disconnect between financial goals and sustainability objectives.

This disconnect stems from a perceived (and often actual) trade-off between environmental improvements and economic performance. Initiatives that promote sustainability and circularity, such as transitioning to renewable energy sources, incorporating recycled materials, or redesigning products for extended lifecycles, are perceived as incurring additional costs without directly contributing to immediate financial gains or even impacting them. Quantifying the net benefit—the balance between environmental gains and economic impacts—is complex and often poorly understood, and much needed.

There is a need for decision-support tools that can clearly assess and evaluate the types of trade-offs outlined above and implement the decisions to facilitate environmental considerations on the supply chain.

Example implementations described herein can involve a Social Responsibility Score (SRS) along with systems and methods for computing a Social Responsibility Score (SRS) that quantifies the economic and environmental impact of business decisions, allowing for the evaluation and comparison of alternative operational choices based on organizational priorities. It provides a quantitative assessment of the tradeoffs of alternative business decisions.

Example implementations described herein can involve integrated profit optimization, which can involve systems and methods for incorporating environmental KPIs directly into a profit optimization objective function to create a unified framework for assessing the trade-offs between economic and environmental performance.

Example implementations described herein can involve a multi-Objective optimization formulation and joint optimization, which can involve systems and methods for formulating a multi-objective optimization problem. Example implementations facilitate simultaneously optimizing economic and environmental KPIs through the solution of the multi-objective optimization problem, enabling the identification of solutions that balance profitability and sustainability.

Aspects of the present disclosure can involve a method, which can include collecting data from stakeholders in an industrial value chain; defining and measuring economic key performance indicators (KPIs) and environmental KPIs based on the collected data; formulating a multi-objective optimization problem balancing the economic KPIs and environmental KPIs to generate one or more solutions; computing a social responsibility score (SRS) for the one or more solutions based on the multi-objective optimization; selecting a solution from the one or more solutions for execution across the industrial value chain based on the computed SRS, and executing the selected solution on affected stakeholders across the industrial value chain.

Aspects of the present disclosure can involve a computer program which can include instructions involving collecting data from stakeholders in an industrial value chain; defining and measuring economic key performance indicators (KPIs) and environmental KPIs based on the collected data; formulating a multi-objective optimization problem balancing the economic KPIs and environmental KPIs to generate one or more solutions; computing a social responsibility score (SRS) for the one or more solutions based on the multi-objective optimization; selecting a solution from the one or more solutions for execution across the industrial value chain based on the computed SRS, and executing the selected solution on affected stakeholders across the industrial value chain. The computer program and instructions can be stored on a non-transitory computer readable medium and executed by one or more processors.

Aspects of the present disclosure can involve a system, which can include means for collecting data from stakeholders in an industrial value chain; defining and measuring economic key performance indicators (KPIs) and environmental KPIs based on the collected data; means for formulating a multi-objective optimization problem balancing the economic KPIs and environmental KPIs to generate one or more solutions; computing a social responsibility score (SRS) for the one or more solutions based on the multi-objective optimization; means for selecting a solution from the one or more solutions for execution across the industrial value chain based on the computed SRS, and means for executing the selected solution on affected stakeholders across the industrial value chain.

Aspects of the present disclosure can include an apparatus, which can include a processor, configured to collect data from stakeholders in an industrial value-chain; define and measure economic key performance indicators (KPIs) and environmental KPIs based on the collected data; formulate a multi-objective optimization problem balancing the economic KPIs and environmental KPIs to generate one or more solutions; compute a social responsibility score (SRS) for the one or more solutions based on the multi-objective optimization; select a solution from the one or more solutions for execution across the industrial value chain based on the computed SRS, and execute the selected solution on affected stakeholders across the industrial value chain.

### BRIEF DESCRIPTION OF DRAWINGS

FIG. 1 is an illustration of the proposed system, in accordance with example implementations described herein.

FIG. 2 illustrates an example flow diagram of the joint optimization model, in accordance with an example implementation.

FIG. 3 illustrates an example overall flow of the system, in accordance with an example implementation.

FIG. 4 illustrates a plurality of stakeholders that are networked to a management apparatus, in accordance with an example implementation.

FIG. 5 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

Example implementations involve systems and methods for integrating environmental considerations into traditional business decision-making, enabling the optimization of both economic and environmental performance as well as execution of plans on the supply chain to control the supply chain towards the optimization of economic and environmental performance. A key aspect of the invention is a method for computing a Social Responsibility Score (SRS), which we derive from a multi-objective optimization process that balances economic KPIs with environmental KPIs.

In an example, suppose there is an OEM in the electrical equipment sector that is considering a switch from natural gas-fired ovens to electric ovens and faces a critical decision. While electric ovens could potentially reduce Green House Gas (GHG) emissions, the OEM needs a quantitative assessment that compares the environmental benefits (e.g., reduced carbon footprint) against the associated capital expenditure (CAPEX) for new equipment and potential changes in operating expenses (OPEX) due to increased electricity costs.

In another example, suppose a consumer goods company is evaluating a transition from virgin materials to recycled feedstocks. It needs to assess the tradeoff between the environmental advantages of reduced virgin resource use and waste generation against potential financial implications, which included the cost of recycled materials, impact to production equipment and processes, potential impacts on product quality, and the resulting impact to revenue and profit margins.

Businesses lack the methodologies and tools to systematically evaluate the integrated economic and environmental consequences of their decisions. They need approaches to move beyond qualitative assessments and high-level assessments to make data-driven decisions that optimize for both profitability and sustainability across their entire value chain. Specifically, systems, tools and approaches are needed to:
1. Connect the stakeholders in the industrial value-chain, enable collection of data, and compute and optimize the KPIs
2. Define relevant economic and environmental KPIs across their entire value chain (from raw material sourcing to end-of-life product management) and measure these KPIs consistently.
3. Simultaneously optimize both economic and environmental performance, enabling informed decision-making that balances profitability with sustainability and resource efficiency. Assess the tradeoffs between KPIs, make decisions and enable operationalization of the decisions.

To address the example problems above, example implementations described herein involve systems and methods to address the critical need for integrated economic and environmental performance management and balancing of KPIs. The example implementations described herein offer several key benefits over existing methods and enables businesses to move beyond qualitative assessments to make data-driven decisions that optimize for both profitability and sustainability. The example implementations described herein can facilitate the following benefits.

Integrated Assessment and Optimization: Unlike related art approaches that treat economic and environmental performance as separate, often conflicting, objectives, the example implementations described herein provide a unified framework for defining, measuring, and simultaneously optimizing a comprehensive set of economic and environmental KPIs. This integration allows businesses to understand and manage the complex interdependencies between these factors, leading to more informed decision-making.

Measurable Sustainability: The example implementations enable manufacturers to make operations more sustainable in a measurable way with minimal and measurable economic impact.

Quantitative Decision Support: The example implementations described herein go beyond high-level sustainability targets and provides a practical, quantitative methodology for evaluating the trade-offs between different operational choices. By evaluating various scenarios and assessing the utility and impact of optimized solutions, businesses can identify the most effective strategies for achieving sustainability and circularity while maintaining or even improving profitability. For example, this includes, determining the optimal mix of energy sources, mix of virgin and recycled materials, assessing the impact of waste treatment and wastewater treatment, and decisions related to process choices.

Data-Driven Circularity: The system of the example implementations facilitates the collection and analysis of relevant data across the value chain, which enables businesses to track their progress towards circularity goals and identify areas for improvement. The data-driven approach utilized herein enables transparency and accountability, allowing businesses to demonstrate the tangible benefits of their sustainability initiatives.

Comprehensive Value Chain Coverage: The example implementations encompass KPIs that span the entire value chain, from raw material procurement and production processes to product use, end-of-life management, and resource recovery. This ensures that decisions are not made in isolation and that potential consequences across the value chain are considered, which are critical for achieving a global optimization.

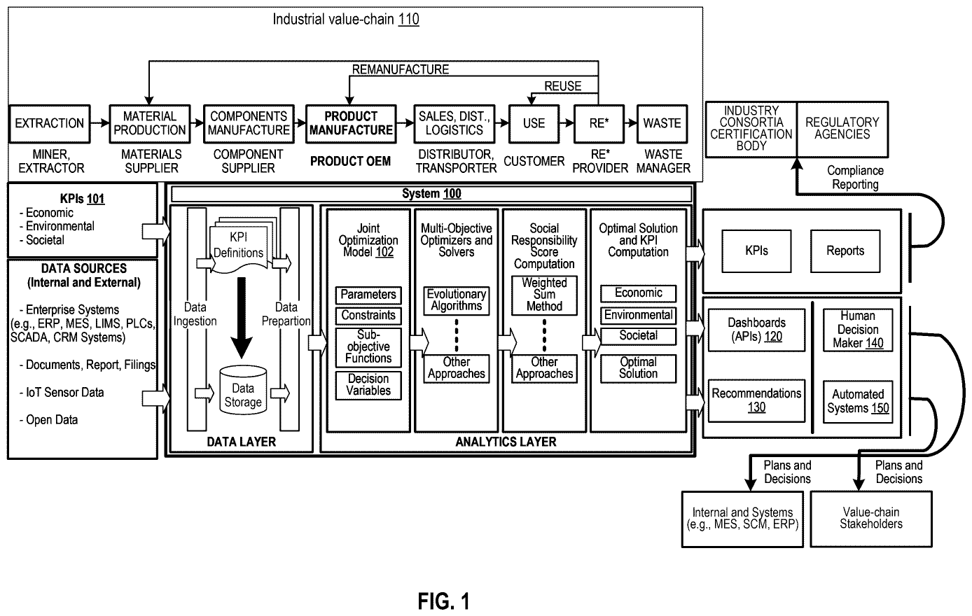

FIG. 1 is an illustration of the proposed system, in accordance with example implementations described herein. Example implementations described herein involve a systematic approach to comprehensively measure and jointly optimize economic and environmental KPIs, enabling businesses to make informed decisions that drive both profitability and sustainability, as well as to execute such decisions and optimizations across the supply chain.

In example implementations, there is a systems approach to transform businesses to a circular economy, establish efficient closed loops and RE-X pathways, and address specific challenges through any desired implementation as is known in the art. Such example implementations also involve an approach to measure circular economy KPIs across the value-chain in accordance with any implementation as is known in the art.

The systems approach is extended in example implementations described herein to add a sustainability and circularity KPIs measurement, optimization and decision-support framework as shown in system 100. System 100 connects the stakeholders in the industrial value-chain 110 (suppliers, manufacturers, logistics providers, customers, and recyclers, as well as industry and certification bodies and regulatory agencies), facilitates collection of the necessary data from these stakeholders, and computes and optimizes the KPIs. Through KPI optimization, it balances the economic and environmental impact of the operations. Further, System 100 generates optimal decisions and recommendations 130 that can maximize the KPIs under the constraints and preferences of the decision-making entity. Such decisions pertain to both internal systems (e.g., production systems and processes) as well as external value-chain (e.g., procurement decisions). The decisions can be presented through a dashboard 120 to a human decision maker 140 who can review them and take appropriate actions. The decisions can also be fed directly to an automated system 150 for actions and operationalization across the industrial value-chain 110. The actions could be operational actions (such as determining production schedule or sales and operations plan internally) or could be more strategic actions such as a selection of production processes or a selection of raw-material and energy mix.

### Defined and Measured KPIs 101

Example implementations described herein involve a comprehensive framework to define KPIs 101 that are relevant for industrial operations in a circular economy. These KPIs 101 span economic and environmental dimensions, and depending on the desired implementation, can involve societal dimensions as well. Effectively computing such KPIs 101 requires data from the entire value-chain from raw material procurement to production, distribution, product use, end-of-life, and recovery. While the decisions that the KPIs 101 will influence may be limited to a stakeholder, their impact can potentially span the entire value chain.

The exact set of KPIs 101 will depend on several factors, such as the specific industry sector, operational processes and regulatory and business environment. However, a few widely applicable KPIs include the following.

### Economic KPIs

Revenues: Sales revenue from primary products and recovered materials.

Costs: Raw material costs (including recycled materials); production costs including indirect costs; labor costs; logistics costs; waste management costs; capital expenses; operating expenses; cost of energy

Penalties: Associated with environmental impact such as emissions, effluents.

Carbon credits and other instruments: Cost of purchasing such instruments to offset environmental impact.

Profits: Overall profitability considering all costs and revenues.

### Environmental KPIs

Greenhouse Gas (GHG) Emissions: Scope 1, 2, and 3 emissions.

Energy Consumption: Total energy used, including electricity and fuels; energy mix including proportion of renewable energy and non-renewable energy.

Water Consumption: Total water used in operations; wastewater discharged.

Recovered Material Use: Percentage of recycled or remanufactured materials used in production.

Recovery rate: Amount of material recovered at end of use.

Waste Generation: Amount of waste generated, including hazardous and non-hazardous waste; amount of waste processed.

Effluents: Volume and composition of liquid waste discharged.

These KPIs 101 can be measured comprehensively using a framework as illustrated in System 100. In the initial phase, data can also be collected from company's internal systems, reports, and industrial standards. The system can also utilize data from open sources and other systems as well (such as material informatics systems) For some KPIs 101, proxies may be used until an automated data capture process is established.

Once the set of economic and environment KPIs are identified, they are parsed through a joint optimization model 102 to jointly optimize the KPIs to maximize profit, factoring in the costs and constraints of the environment KPIs. The goal is to balance profitability, which is what the businesses care about the most, with sustainability, which is a key goal.

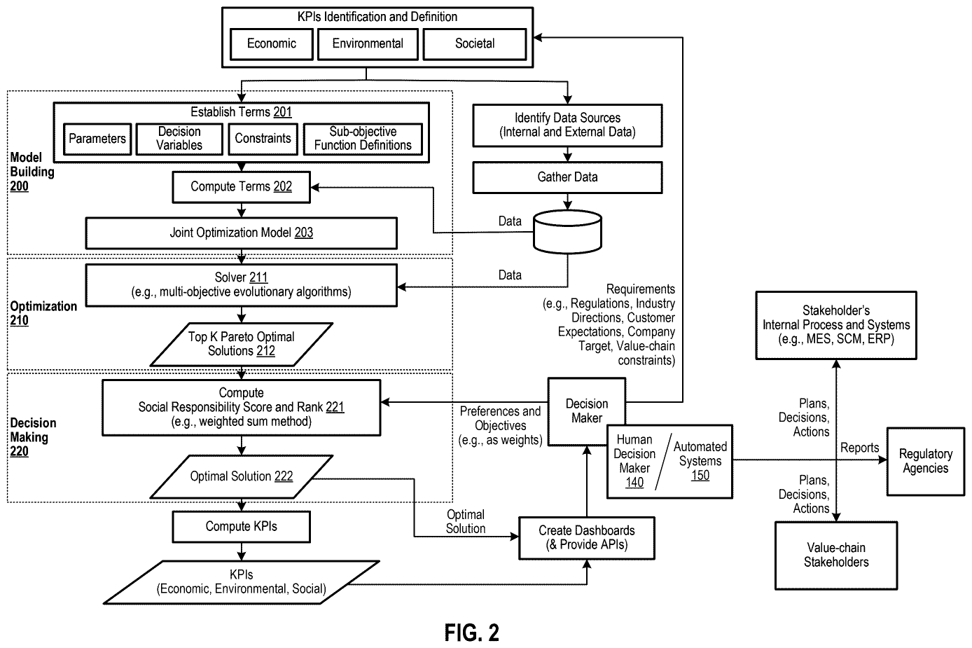

FIG. 2 illustrates an example flow diagram of the joint optimization model 102, in accordance with an example implementation.

For this, a joint optimization model is built under model building 200. For the model, the flow first establishes the terms at 201 including decision variables, parameters, constraints and sub-objective problems. Then, at 202, the flow computes the terms based on the data extracted from internal and external systems. Subsequently, the joint optimization model 203 is formulated as a multi-objective optimization problem at 211 during the optimization process 210.

Specifically, the joint optimization problem is formulated on a select set of KPIs and assumes production of a single product p. The approach can be extended to a broader set of KPIs and to multiple products, depending on the desired implementation. Table 1 below presents the notation and definitions used in the model formulation. Table 2 below outlines the constraints incorporated into the model.

TABLE 1
Notations and Definitions

| | |
|---|---|
| Notation | Definition |

Sets

| | |
|---|---|
| T | Set of time periods (e.g., months, quarters) |
| R | Set of raw materials including recycled materials |
| J | Set of energy types (e.g., electrical, thermal) |
| E | Set of energy sources. Different sources may provide same type of |
| | energy (e.g., solar and wind will be considered different sources |
| | electricity) |
| M | Set of production processes for producing p. Each process may have a |
| | different input, production process, consumption and output profile, but |
| | will produce an equivalent unit of product p. |
| W | Set of waste types |
| N | Set of methods for treating waste |
| L | Set of regulations for different aspects. For example, it may include |
| | following subsets: |
| | L^{Emissions}: Penalty or taxation rate for emissions |
| | L^{Toxic}: Penalty or taxation rate for releasing toxic air pollutants |
| | L^{Effluents}: Penalty or taxation rate for wastewater discharge |
| | L^{Waste}: Penalty or taxation rate for waste, by waste type |

Decision Variables

| | |
|---|---|
| X_{m,t} | Quantity of product p produced using method m in period t with m ∈ M |
| | and t ∈ T |
| Sₜ | Quantity of product p sold in period t with t ∈ T |
| I_{r,t} | Quantity of raw material r consumed in period t with r ∈ R and t ∈ T |
| Hₜ | Amount of labor needed in period t with t ∈ T |
| Y_{j,e,t} | Quantity of energy of type j from source e consumed in period t with j ∈ |
| | J, e ∈ N and t ∈ T |
| Uₜ | Quantity of water consumed in period t with t ∈ T |
| Qₜ | Quantity of treated water discharged in period t with t ∈ T |
| Vₜ | Quantity of wastewater (i.e., untreated water) discharged in period t with |
| | t ∈ T |
| G_{w,t} | Quantity of waste of type w generated in period t with w ∈ W and t ∈ T |
| Z_{w,n,t} | Quantity of waste of type w treated with method n in period t with w ∈ |
| | W, n ∈ N and t ∈ T |
| Kₜ | Quantity of toxic pollutants released in period t with t ∈ T |
| Aₜ | Number of carbon credits bought in period t with t ∈ T |

Parameters

| | |
|---|---|
| Dₜ | Demand for product p in period t with t ∈ T |
| Pₜ | Selling price for product p in period t with t ∈ T |
| ${C}_{r , t}^{material}$ | Unit cost of raw material r in period t with r ∈ R and t ∈ T |
| ${C}_{t}^{labor}$ | Unit cost of labor in period t with t ∈ T |
| ${C}_{t}^{indirect}$ | Total indirect cost associated with total production of product p in period t with t ∈ T |
| ${C}_{t}^{carbon}$ | Cost of unit of carbon credit in period t with t ∈ T |
| Capₜ | Production capacity for product p in period t with t ∈ T |
| | The formulation can be extended to distinguish production capacity by |
| | manufacturing method |
| α_{m,j} | Quantity of energy of type j required to produce one unit of product p |
| | using process m with j ∈ J and m ∈ M |
| β_{m,r} | Quantity of raw material r required to produce one unit of product p |
| | produced using process m with r ∈ R and m ∈ M |
| λₘ | Quantity of labor required to produce one unit of product p produced |
| | using process m with m ∈ M |
| δₘ | Water usage for producing one unit of product p produced using process |
| | m with m ∈ M |
| γ_{m,w} | Quantity of waste of type w generated from producing one unit of product |
| | p using process m with w ∈ W and m ∈ M |
| ηₘ | Quantity waste water discharge per unit of product p produced using |
| | process m with m ∈ M |
| κₘ | Quantity of toxic air pollutants discharged per unit of product p produced |
| | using process m with m ∈ M |
| ρ_{j,e,t} | Unit cost of energy of type j from source e in period t with j ∈ J, e ∈ E |
| | and t ∈ T |
| υₜ | Unit cost of water in period t with t ∈ T |
| τ_{w,n,t} | Cost of treating one unit of waste of type w with method n in period t with |
| | w ∈ W, n ∈ N and t ∈ T |
| ωₜ | Cost of treating one unit of wastewater in period t with t ∈ T |
| μ_{l,t} | Penalty of taxation rate associated with regulation I in period t with l ∈ L |
| | and t ∈ T |
| ε_{j,e,t} | GHG emissions per unit of energy of type j consumed from source e in |
| | period t with j ∈ J, e ∈ E and t ∈ T |
| φᵣ | Emission factor for raw material r with r ∈ R |
| ψ_{w} | Emission factor for waste type w with w ∈ W |
| σ_{w,n} | Emission factor for treatment method n when treating waste type w with |
| | n ∈ N and w ∈ W |
| θ | Emission factor for water treatment method |

TABLE 2
Constraints

| Type | Constraint |
|---|---|
| Demand | Sₜ ≤ Dₜ ∀ t ∈ T |
| Satisfaction | Assumption is there is no inventory or buffer stock |
| Labor | Σₘ(X_{m, t} * λₘ) = Hₜ ∀ m ∈ M, t ∈ T |
| Production Capacity | Σₘ X_{m, t} ≤ Capₜ ∀ m ∈ M, t ∈ T |
| Raw Material | Σₘ(X_{m, t} * β_{m, r}) = I_{r, t} ∀ m ∈ M, r ∈ R, t ∈ T |
| Balance | |
| Energy | Σₘ(X_{m, t} * α_{m, j}) = Σₑ Y_{j, e, t} I_{r, t} ∀ m ∈ M, j ∈ J, e ∈ E, t ∈ T |
| Consumption | |
| Water Usage | Σₘ(X_{m, t} * δₘ) = Uₜ ∀ m ∈ M, t ∈ T |
| Toxic Air Pollutants | Σₘ(X_{m, t} * κₘ) = Kₜ ∀ m ∈ M, t ∈ T |
| Discharged | |
| Wastewater | Σₘ(X_{m, t} * ηₘ) = Vₜ ∀ m ∈ M, t ∈ T |
| Discharged | |
| Waste | Σₘ(X_{m, t} * γ_{m, w}) = G_{w, t} ∀ w ∈ W, m ∈ M, t ∈ T |
| Waste Treatment | Σₙ Z_{w, n, t} * ≤ G_{w, t} ∀ w ∈ W, n ∈ N, t ∈ T |
| Wastewater | Qₜ + Vₜ ≤ Uₜ ∀ t ∈ T |
| Treatment | |
| Non-Negativity | Sₜ, Dₜ, X_{m, t}, I_{r, t}, Qₜ, Uₜ, Vₜ, Y_{j, e, t}, G_{w, t}, Z_{w, n, t} ≥ 0 |

Next, an objective function for profit is defined. It includes sales revenue, costs associated with production and operation, penalties or taxation related to the environmental footprint of operation (such as emissions or air pollutants or effluents or waste). If a particular aspect is not applicable to a use-case, it can be set as zero. The components of the objective function are defined in (Table 3).

TABLE 3
Components of the Profit objective

| Component | | Notation | Formula |
|---|---|---|---|
| Sales Revenue | | [symbol] | Σₜ(Pₜ * Sₜ) |
| Costs | Indirect | [symbol] | ${\sum }_{t} {C}_{t}^{indirect}$ |
| | Raw Material | [symbol] | ${\sum }_{r , t} ( {C}_{r , t}^{material} * {I}_{r , t} )$ |
| | Labor | [symbol] | ${\sum }_{t} ( {C}_{t}^{labor} * {H}_{t} )$ |
| | Energy | [symbol] | Σ_{j,e,t}(ρ_{j,e,t} * Y_{j,e,t}) |
| | Water | [symbol] | Σₜ(Uₜ * υₜ) |
| | intake | | |
| | Water | [symbol] | Σₜ(Qₜ * ωₜ) |
| | Treatment | | |
| | Waste | [symbol] | Σ_{w,n,t}(τ_{w,n,t} * Z_{w,n,t}) |
| | Treatment | | |
| | Carbon Credits | [symbol] | ${\sum }_{t} ( {C}_{t}^{carbon} * {A}_{t} )$ |
| Penalties | Emissions | [symbol] | Σₜμ_{l,t} * (Σᵣ(φᵣ * I_{r,t}) + Σ_{j,e}(ε_{j,e,t} * |
| | | | Y_{j,e,t}) + Σ_{w,n}(ψ_{w} * (G_{w,t} − Z_{w,n,t})) + Σ_{w,n}(σ_{w,n} * |
| | | | Z_{w,n,t}) + θ * Qₜ) ∀l ∈ L^{Emissions} |
| | Wastewater | [symbol] | Σₜ(μ_{l,t} * Vₜ) ∀l ∈ L^{Effluents} |
| | Toxic Air | [symbol] | Σₜ(μ_{l,t} * Kₜ) ∀l ∈ L^{Toxic} |
| | Pollutants | | |
| | Waste | [symbol] | Σ_{w,n,t}(μ_{l,t} * (G_{w,t} − Z_{w,n,t})) ∀l ∈ L^{Waste} |

The objective is to maximize the profit while meeting the regulatory requirements and corporate targets:

Profit Objective=Maximize ( [symbol] −( [symbol] + [symbol] + [symbol] + [symbol] + [symbol] + [symbol] + [symbol] + [symbol] )−( [symbol] + [symbol] + [symbol] + [symbol] )), that is

$$Profit Objective = Maximize {\sum }_{t} ( {P}_{t} * {S}_{t} ) - ( {\sum }_{t} {C}_{t}^{indirect} + {\sum }_{r , t} ( {C}_{r , t}^{material} * {I}_{r , t} ) + {\sum }_{t} ( {C}_{t}^{labor} * {H}_{t} ) + {\sum }_{j , e , t} ( {ρ}_{j , e , t} * {Y}_{j , e , t} ) + {\sum }_{t} ( {U}_{t} * {v}_{t} ) + {\sum }_{t} ( {Q}_{t} * {ω}_{t} ) + {\sum }_{w , n , t} ( {τ}_{w , n , t} * {Z}_{w , n , t} ) + {\sum }_{t} ( {C}_{t}^{carbon} * {A}_{t} ) ) - ( {\sum }_{l , t} {μ}_{l , t} * ( {\sum }_{r} ( {ϕ}_{r} * {I}_{r , t} ) + {\sum }_{j , e} ( {ε}_{j , e , t} * {Y}_{j , e , t} ) + {\sum }_{w , n} ( {ψ}_{w} * ( {G}_{w , t} - {Z}_{w , n , t} ) ) + {\sum }_{w , n} ( {σ}_{w , n} * {Z}_{w , n , t} ) + θ * {Q}_{t} ) + {\sum }_{l , t} ( {μ}_{l , t} * {V}_{t} ) + {\sum }_{t} ( {μ}_{l , t} * {K}_{t} ) + {\sum }_{l , w , n , t} ( {μ}_{l , t} * ( {G}_{w , t} - {Z}_{w , n , t} ) ) ) )$$

The defined objective function is optimized using a multi-objective optimization model or Mixed Integer Programming (MIP) approach to handle both discrete and continuous variables. This optimization process identifies the most effective strategies and operational decisions for achieving circular economy goals while ensuring financial performance defined in terms of profit.

By considering factors such as production quantity, energy mix, waste processing, and water treatment, the model identifies optimal operating points that balance economic returns with environmental impact. The optimization process may generate multiple solutions, from which the Top-K Pareto optimal strategies are selected for further analysis as shown at 212.

For each of the Top-K strategies, specific KPIs are computed (as presented in Table 4). This allows for a comprehensive and deeper evaluation of the economic and environmental performance of each strategy.

TABLE 4
KPI Computation

| KPI | Formulation |
|---|---|
| Profit | Handled by the objective function |
| GHG Emissions | Σᵣ(φᵣ * I_{r,t}) + Σ_{j,e}(ε_{j,e,t} * Y_{j,e,t}) + Σ_{w,n}(ψ_{w} * |
| | (G_{w,t} − Z_{w,n,t})) + Σ_{w,n}(σ_{w,n} * Z_{w,n,t}) + θ * Qₜ |
| Renewable Energy Percentage | $\frac{( {\sum }_{e ∈ Renewables} {Y}_{j , e , t} ) * 100}{{\sum }_{e} {Y}_{j , e , t}}$ |
| Recycled Material Percentage | $\frac{( {\sum }_{r ∈ Recycled} {I}_{r , t} ) * 100}{{\sum }_{r} {I}_{r , t}}$ |
| Water Usage | Uₜ |
| Wastewater discharge | Vₜ |
| Toxic Air Pollutants | Kₜ |
| Waste Generation | Σ_{w,n,t}(G_{w,t} − Z_{w,n,t}) |
| Waste Recycling Percentage | $\frac{( {\sum }_{e ∈ Recycle} {Z}_{w , n , t} ) * 100}{{\sum }_{w} {G}_{w , t}}$ |

Illustrative example: Consider a manufacturer aiming to maximize profit while evaluating various operational changes: recycled input percentages, production processes, energy sources, and waste management. Applying the proposed joint optimization approach, the manufacturer identified three top-performing scenarios (i.e. Top 3 pareto optimal strategies). These are illustrated in Table 5. Scenario A leverages process A, which is reliant on natural gas as the key energy source. Scenario B shifts to process B, using renewable electricity (at a higher cost but lower emissions) and generating less waste. Scenario C entails a third process C with a mixed energy sources and higher-quality, more expensive feedstock but resulting in reduced waste and wastewater.

TABLE 5
Illustrative example - top-3 highest profit
options after joint optimization of the KPIs

| | | GHG | Waste | |
|---|---|---|---|---|
| | Profit | Emissions | Generation | Wastewater |
| | ($) | (tons-CO₂) | (tons) | (m³) |
| Scenario A | 1,000,000 | 550 | 150 | 3,500 |
| Scenario B | 970,000 | 200 | 110 | 3,500 |
| Scenario C | 965,000 | 400 | 60 | 2,800 |

The optimal scenario is selected based on the decision-maker's priorities. For example, if minimizing GHG emissions is paramount, Scenario B (and process B) becomes the preferred choice, despite a potential reduction in profit, due to its significant CO2 reduction. We will outline a systematic approach to facilitate this selection process next.

To facilitate decision-making 220 among the top optimal strategies and capture the interdependencies and tradeoffs between KPIs, a Social Responsibility Score (SRS) and rank is computed at 221. This utility function represents the overall performance of the system, considering the interplay of individual KPIs. This function represents the overall performance of the system as a function of the individual KPIs. The utility function represents the preferences of the decision-maker and in this context, it can be used to evaluate the trade-offs between economic and environmental KPIs. It can make the decision making such as in the illustrative example above easier.

The SRS can be calculated by using a weighted sum of the KPIs, where the weights represent the relative importance of each KPI. This approach allows for a flexible and customizable evaluation framework that aligns with the specific priorities and values of the decision-maker. These priorities and values may be derived from multiple factors including, regulations, company targets, industry directives, customer expectations, or value-chain constraints.

$$SRS = {w}_{1} * {KPI}_{1} + {w}_{2} * {KPI}_{2} + … {w}_{n} * {KPI}_{n}$$

where:
SRS is the overall utility (social responsibility score), wᵢ is the weight assigned to the i^{th} KPI, and KPIᵢ is the value of the i^{th} KPI.

This approach allows for a flexible and customizable evaluation framework that aligns with the specific priorities and values of the decision-maker. These priorities and values may be derived from multiple factors including regulations, company targets, industry directives, customer expectations, or value-chain constraints. For instance, one company may want to reduce their GHG emissions and hence provide higher weightage to GHG related KPI, while another may want to reduce waste and weigh waste reduction higher. From a standardization perspective, the weights may be defined by an industry consortia or regulatory organizations.

For instance, let's consider the manufacturer from the illustrative example in the previous section. The manufacturer is focused on the KPIs: Profit (P), Emissions (E), Waste (W) and Water Usage (H). The utility score may be represented as:

$$SRS = {w}_{p} * P + {w}_{e} * E + {w}_{w} * W + {w}_{h} * H$$

The manufacturer picked weights as follows:
Weight for profit, wₚ=1
Weight for emissions, wₑ=−$50 per Ton-CO₂ (approximated from Social Cost of Carbon)
Weight for waste, w_{w}=−$300 per Ton (approximated from waste cleaning expenses)
Weight for water usage, wₕ=−$5 per Ton (approximated from wastewater treatment costs) (negative weights representing costs)
Applying these weights to the example scenarios in Table 5, utilities for each scenario can be calculated (Table 6).

TABLE 6
Illustrative example - computation of utility from KPIs

| | | GHG | Waste | | |
|---|---|---|---|---|---|
| | Profit | Emissions | Generation | Wastewater | SRS |
| | ($) | (tons-CO₂) | (tons) | (m³) | ($) |
| Scenario A | 1 × 1,000,000 | −$50 × 550 | −$300 × 150 | −$5 × 3,500 | 910,000 |
| Scenario B | 1 × 970,000 | −$50 × 200 | −$300 × 110 | −$5 × 3,500 | 909,500 |
| Scenario C | 1 × 965,000 | −$50 × 450 | −$300 × 60 | −$5 × 2,800 | 910,500 |

In this simplified example, though Scenario A maximizes profit, Scenarios B and C, based on the manufacturer's weighted KPIs utility (SRS), are comparable, with C marginally better. The manufacturer should choose Scenario B for GHG reduction or Scenario C for waste and water minimization. Depending on the desired implementation, the information as described with respect to Table 6 can be provided through an interface so that the decision maker can select the desired solution to implement onto the stakeholders. Such an interface can be implemented through any desired implementation known in the art, such as a graphical user interface (GUI) configured to intake a selection (e.g., selecting Scenario A, B, or C when presented), whereupon the execution of the selection can involve transmission of instructions to the appropriate stakeholder or to automated systems to execute control on stakeholder systems.

Table 7 demonstrates the sensitivity of the utility score SRS to weights. For instance, a 10% change in a weight can alter the optimal scenario. Therefore, it is crucial to assign weights that accurately reflect the decision-maker's priorities and requirements. Standardizing weights through government or industry consortia would set benchmarks and enable objective comparisons. Accordingly, an interface can be provided for the decision maker to adjust the weights according to their desired implementation. Such an interface can be implemented through any desired implementation known in the art, such as a graphical user interface (GUI) configured to intake values for each of the weights.

TABLE 7
Impact of changing weights on utility, SRS (optimal scenario in bold)

| | | 10% Decrease in (Absolute) | | | | 10% Increase in (Absolute) | | | |
|---|---|---|---|---|---|---|---|---|---|
| | | Weight Value | | | | Weight Value | | | |
| | Original | New | | | | New | | | |
| Weight | Weight | Weight | Scenario A | Scenario B | Scenario C | Weight | Scenario A | Scenario B | Scenario C |
| wₑ | −50 | −45 | 912,750 | 910,500 | 912,750 | −55 | 907,250 | 908,500 | 908,250 |
| w_{w} | −300 | −270 | 914,500 | 912,800 | 912,300 | −330 | 905,500 | 906,200 | 908,700 |
| wₕ | −5 | −4.5 | 911,750 | 911,250 | 911,900 | −5.5 | 908,250 | 907,750 | 909,100 |

Once the scenario representing the optimal decision 222 has been determined, it can be operationalized by either a human decision maker 140 or provided to an automated system 150. The actions driven by these decisions can range from internal operational adjustments (e.g., production schedules, sales and operations plans) to strategic choices (e.g., production process selection, raw material and energy mix). The decision can influence both the stakeholders' internal processes as well as impact on the value-chain stakeholders. In addition, the system can be connected to regulatory bodies and certification agencies and provide regulatory or compliance reporting on an automated basis.

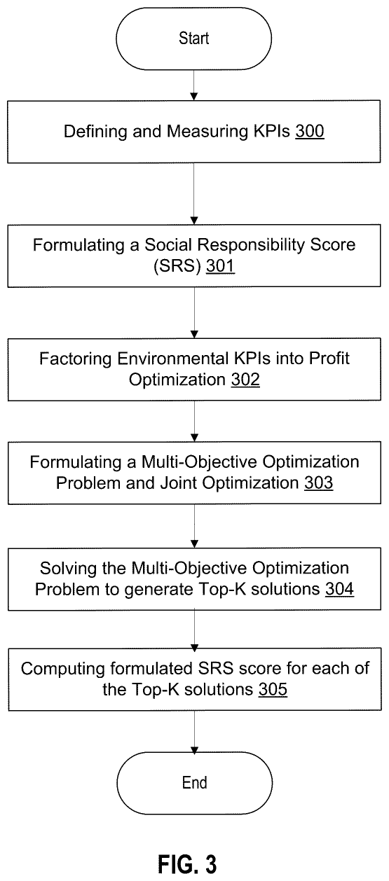

FIG. 3 illustrates an example overall flow of the system, in accordance with an example implementation. At 300, the flow defines and measures KPIs. Specifically, the flow executes the identifying and measuring of a comprehensive set of relevant economic KPIs (e.g., revenue, profit, cost) and environmental KPIs (e.g., energy mix, resource consumption, waste generation, emissions).

At 301, the flow formulates a social responsibility score (SRS). Specifically, the flow develops a quantifiable SRS that reflects the organization's priorities and allows for the evaluation of the economic and environmental impact of business decisions. The SRS is designed to be flexible and adaptable to different organizational contexts and priorities. It facilitates quantitative assessment of tradeoffs of alternative business decisions. It also provides a means to clearly communicate the impact of decisions made.

At 302, the flow factors environmental KPIs into the profit optimization. Specifically, the flow integrates the defined KPIs into a profit optimization objective function. This creates a unified approach for assessing the trade-offs between economic and environmental performance.

At 303, the flow formulates a Multi-Objective Optimization Problem and Joint Optimization. Specifically, the flow constructs a multi-objective optimization problem that balances and optimizes the economic and environmental KPIs. This enables the identification of solutions (representing plans) that maximize both profitability and minimizes environmental impact.

At 304, the Multi-Objective Optimization Problem is solved to generate the top-K solutions, where K can be set in accordance with the desired implementations. The solutions that are generated are solutions and actions that can be taken by a stakeholder user when pushed to the stakeholder, and/or actions that autonomously control functions or machinery at the stakeholders.

At 305, the formulated SRS is computed for each of the top-K solutions to present one or more solutions for selection on an interface. The user can then, through their interface, select the desired solution based on the top-K solutions and their associated SRS score to push onto the stakeholders.

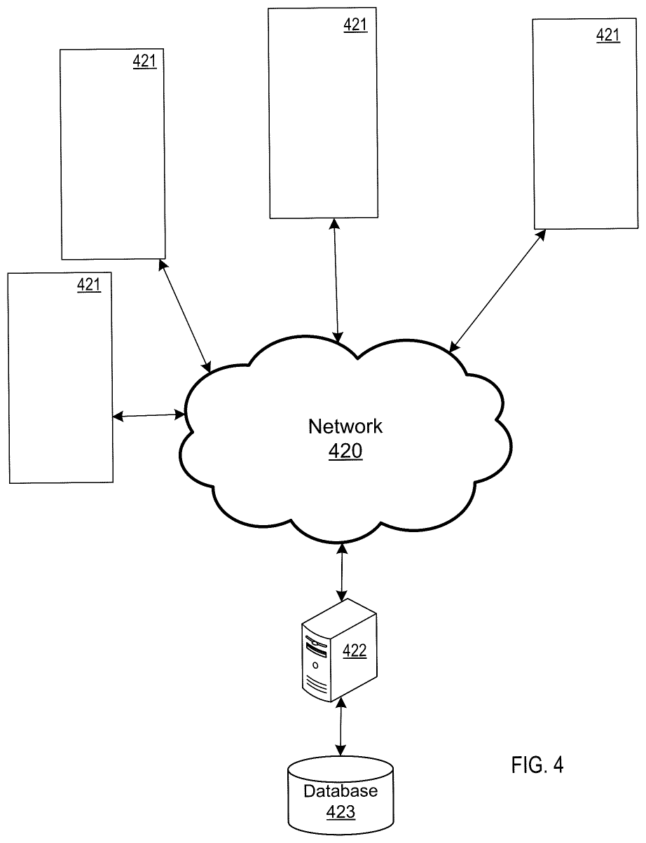

FIG. 4 illustrates a plurality of stakeholders that are networked to a management apparatus, in accordance with an example implementation. One or more stakeholders 421 (e.g., suppliers, manufacturers, logistics providers, customers, recyclers, industry bodies, certification bodies, or regulatory agencies, and so on) can involve physical machines and equipment (e.g., server racks, switches/routers, storage systems, etc.) that are communicatively coupled to a network 420 (e.g., local area network (LAN), wide area network (WAN)) through the corresponding network interface used by the stakeholders 421, which is connected to a management apparatus 422 configured to facilitate the functionality for pushing the selected solution to the one or more stakeholders 421 for execution. The one or more stakeholders 421 may have an interface to intake the solution from the management apparatus 422 for fulfillment depending on the underlying stakeholder (e.g., purchase orders to suppliers, submissions for regulatory compliance, specifications for designs, etc.) as well as an interface to automatically execute solutions (e.g., controlling factory machines to shut down for periods of time, controlling energy sources, modifying machine settings, etc.) and directly control underlying physical machines and equipment to facilitate the solution autonomously. The management apparatus 422 manages a database 423, which contains information collected from stakeholders 421. In alternate example implementations, the information may be provided to the central repository or central database.

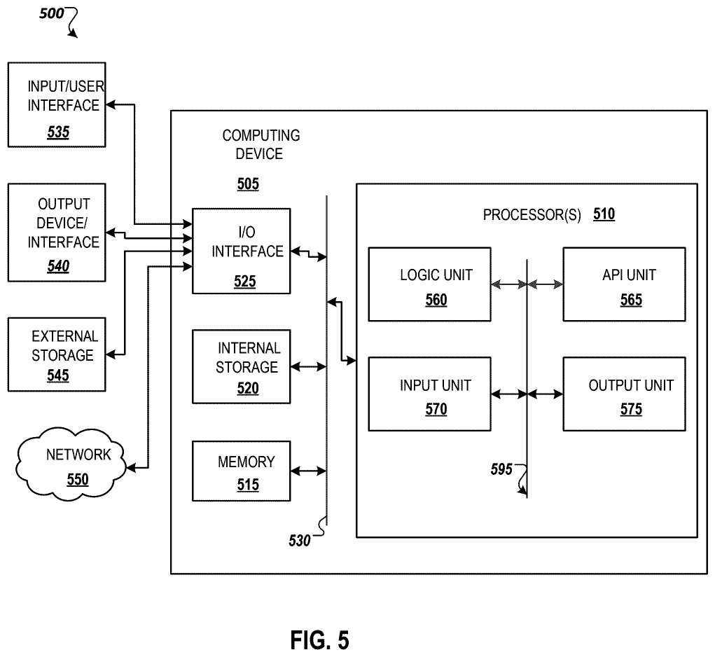

FIG. 5 illustrates an example computing environment with an example computer device suitable for use in some example implementations, such as the management apparatus 422 configured to push solutions to corresponding stakeholders. Computer device 505 in computing environment 500 can include one or more processing units, cores, or processors 510, memory 515 (e.g., RAM, ROM, and/or the like), internal storage 520 (e.g., magnetic, optical, solid state storage, and/or organic), and/or I/O interface 525, any of which can be coupled on a communication mechanism or bus 530 for communicating information or embedded in the computer device 505. I/O interface 525 is also configured to receive images from cameras or provide images to projectors or displays, depending on the desired implementation.

Computer device 505 can be communicatively coupled to input/user interface 535 and output device/interface 540. Either one or both of input/user interface 535 and output device/interface 540 can be a wired or wireless interface and can be detachable. Input/user interface 535 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 540 may include a display, television, monitor, printer, speaker, braille, or the like. In some example implementations, input/user interface 535 and output device/interface 540 can be embedded with or physically coupled to the computer device 505. In other example implementations, other computer devices may function as or provide the functions of input/user interface 535 and output device/interface 540 for a computer device 505.

Examples of computer device 505 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 505 can be communicatively coupled (e.g., via I/O interface 525) to external storage 545 and network 550 for communicating with any number of networked components, devices, and systems, including one or more computer devices of the same or different configuration. Computer device 505 or any connected computer device can be functioning as, providing services of, or referred to as a server, client, thin server, general machine, special-purpose machine, or another label.

I/O interface 525 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 500. Network 550 can be any network or combination of networks (e.g., the Internet, local area network, wide area network, a telephonic network, a cellular network, satellite network, and the like).

Computer device 505 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 505 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 510 can execute under any operating system (OS) (not shown), in a native or virtual environment. One or more applications can be deployed that include logic unit 560, application programming interface (API) unit 565, input unit 570, output unit 575, and inter-unit communication mechanism 595 for the different units to communicate with each other, with the OS, and with other applications (not shown). The described units and elements can be varied in design, function, configuration, or implementation and are not limited to the descriptions provided. Processor(s) 510 can be in the form of hardware processors such as central processing units (CPUs) or in a combination of hardware and software units.

In some example implementations, when information or an execution instruction is received by API unit 565, it may be communicated to one or more other units (e.g., logic unit 560, input unit 570, output unit 575). In some instances, logic unit 560 may be configured to control the information flow among the units and direct the services provided by API unit 565, input unit 570, output unit 575, in some example implementations described above. For example, the flow of one or more processes or implementations may be controlled by logic unit 560 alone or in conjunction with API unit 565. The input unit 570 may be configured to obtain input for the calculations described in the example implementations, and the output unit 575 may be configured to provide output based on the calculations described in example implementations.

Processor(s) 510 can be configured to execute a method or instructions that include collecting data from stakeholders in an industrial value-chain; defining and measuring economic key performance indicators (KPIs) and environmental KPIs based on the collected data; formulating a multi-objective optimization problem balancing the economic KPIs and environmental KPIs to generate one or more solutions; computing a social responsibility score (SRS) for the one or more solutions based on the multi-objective optimization; selecting a solution from the one or more solutions for execution across the industrial value chain based on the computed SRS, and executing the selected solution on affected stakeholders across the industrial value chain as illustrated in FIGS. 1-4 and in the examples from Tables 1 to 7. As illustrated in the examples from Tables 1 to 7, the economic KPIs can include revenue, profit, and cost, and the environmental KPIs can include energy mix, resource consumption, waste generation, and greenhouse gas emissions.

Processor(s) 510 can be configured to execute the method or instructions as described above, and further include providing an interface to adjust weights used in computing the SRS as described with respect to Table 7.

Processor(s) 510 can be configured to execute the method or instructions as described above, and further include providing an interface to provide the one or more solutions for the selecting of the solution and executing the selected solution.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
collecting data from stakeholders in an industrial value chain;
defining and measuring economic key performance indicators (KPIs) and environmental KPIs based on the collected data;
formulating a multi-objective optimization problem balancing the economic KPIs and the environmental KPIs to generate one or more solutions;
computing a social responsibility score (SRS) for the one or more solutions based on the multi-objective optimization;
selecting a solution from the one or more solutions for execution across the industrial value chain based on the computed SRS, and
executing the selected solution on affected stakeholders across the industrial value chain.

2. The method of claim 1, wherein the stakeholders comprise one or more of suppliers, manufacturers, logistics providers, customers, recyclers, industry bodies, certification bodies, or regulatory agencies.

3. The method of claim 1, wherein the economic KPIs comprise revenue, profit, and cost.

4. The method of claim 1, wherein the environmental KPIs comprise energy mix, resource consumption, waste generation, and greenhouse gas emissions.

5. The method of claim 1, further comprising providing an interface to adjust weights used in computing the SRS.

6. The method of claim 1, further comprising providing an interface to provide the one or more solutions for the selecting of the solution and executing the selected solution.

7. A non-transitory computer readable medium, storing instructions for executing a process, comprising:
collecting data from stakeholders in an industrial value chain;
defining and measuring economic key performance indicators (KPIs) and environmental KPIs based on the collected data;
formulating a multi-objective optimization problem balancing the economic KPIs and the environmental KPIs to generate one or more solutions;
computing a social responsibility score (SRS) for the one or more solutions based on the multi-objective optimization;
selecting a solution from the one or more solutions for execution across the industrial value chain based on the computed SRS, and
executing the selected solution on affected stakeholders across the industrial value chain.

8. The non-transitory computer readable medium of claim 7, wherein the stakeholders comprise one or more of suppliers, manufacturers, logistics providers, customers, recyclers, industry bodies, certification bodies, or regulatory agencies.

9. The non-transitory computer readable medium of claim 7, wherein the economic KPIs comprise revenue, profit, and cost.

10. The non-transitory computer readable medium of claim 7, wherein the environmental KPIs comprise energy mix, resource consumption, waste generation, and greenhouse gas emissions.

11. The non-transitory computer readable medium of claim 7, further comprising providing an interface to adjust weights used in computing the SRS.

12. The non-transitory computer readable medium of claim 7, further comprising providing an interface to provide the one or more solutions for the selecting of the solution and executing the selected solution.

13. An apparatus, comprising:
a processor, configured to:
collect data from stakeholders in an industrial value chain;
define and measure economic key performance indicators (KPIs) and environmental KPIs based on the collected data;
formulate a multi-objective optimization problem balancing the economic KPIs and the environmental KPIs to generate one or more solutions;
compute a social responsibility score (SRS) for the one or more solutions based on the multi-objective optimization;
select a solution from the one or more solutions for execution across the industrial value chain based on the computed SRS, and
execute the selected solution on affected stakeholders across the industrial value chain.

14. The apparatus of claim 13, wherein the stakeholders comprise one or more of suppliers, manufacturers, logistics providers, customers, recyclers, industry bodies, certification bodies, or regulatory agencies.

15. The apparatus of claim 13, wherein the economic KPIs comprise revenue, profit, and cost.

16. The apparatus of claim 13, wherein the environmental KPIs comprise energy mix, resource consumption, waste generation, and greenhouse gas emissions.

17. The apparatus of claim 13, wherein the processor is configured to provide an interface to adjust weights used in computing the SRS.

18. The apparatus of claim 13, wherein the processor is configured to provide an interface to provide the one or more solutions for the selection of the solution and the execution of the selected solution.
